(19) United States
(12) Patent Application Publication
(10) Pub. No.: US 2016/0042383 A1
(43) Pub. Date: Feb. 11, 2016

(54) Customer Reward Systems and Methods

(71) Applicant: Netincent, Inc., Saratoga, CA (US)

(72) Inventors: Sunil Pradeep Joshi, Saratoga, CA (US); Kalyan V. Krishnan, Fremont, CA (US)

(21) Appl. No.: 14/821,336

(22) Filed: Aug. 7, 2015

Related U.S. Application Data
(60) Provisional application No. 62/034,737, filed on Aug. 7, 2014.

(51) Int. Cl. G06Q 30/02

(52) U.S. Cl. CPC G06Q 30/0234; G06Q 30/0214; G06Q 30/0238; G06Q 30/0237

(57) ABSTRACT

Example customer reward systems and methods are described. In one implementation, a method receives, through a merchant device, data associated with a purchase transaction by a customer such that the data is entered into the merchant device by a user with knowledge of the transaction. The method determines a customer reward associated with the purchase transaction based on the received data entered by the user with knowledge of the transaction. The customer reward is communicated to a server that maintains a customer reward account associated with the customer. The server is instructed to apply the customer reward to the customer reward account associated with the customer.

### RELATED APPLICATION

This application also claims the priority benefit of U.S. Provisional Application Ser. No. 62/034,737, entitled “CLOUD-BASED CASH-BACK REBATE PROGRAM FOR USE BETWEEN MERCHANTS AND CUSTOMERS”, filed Aug. 7, 2014, the disclosure of which is incorporated by reference herein in its entirety.

### TECHNICAL FIELD

The present disclosure relates to systems and methods that implement, for example, customer reward programs offered by merchants offering goods or services for sale.

### BACKGROUND

Most conventional customer reward programs are integrated with point-of-sale (POS) devices, as implemented by large retailer chains and big box stores, for example. Small retail merchants, such as “mom and pop shops,” in general cannot avail of such customer reward program integration with their respective POS devices. Furthermore, a typical customer reward program as offered by, for example, credit card companies, often do not give a small retail merchant much flexibility with regards to customizing the customer reward program. Therefore, there exists a need for a customer reward program that can be implemented by a small retail merchant offering goods or services.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an embodiment that includes multiple customers and multiple merchants.

FIG. 2 is a block diagram depicting an embodiment that includes a payment entity in addition to a customer device and a merchant.

FIG. 3 is a block diagram depicting an embodiment of the architecture of a merchant device.

FIG. 4 is a block diagram depicting an embodiment of the architecture of a kiosk device.

FIG. 5 is a block diagram depicting an embodiment of the architecture of a customer device.

FIGS. 6A, 6B, and 6C represent a flow diagram depicting an embodiment of a method for issuing a customer reward.

FIGS. 7A and 7B represent a flow diagram depicting an embodiment of a method for reward withdrawal by a customer.

FIG. 8 depicts an embodiment of a user interface on a merchant device.

FIG. 9 depicts another embodiment of a user interface on a merchant device.

FIG. 10 depicts another embodiment of a user interface on a merchant device.

FIG. 11 depicts another embodiment of a user interface on a merchant device.

FIG. 12 depicts an embodiment of a user interface on a customer device.

FIG. 13 depicts another embodiment of a user interface on a customer device.

FIG. 14 depicts an embodiment of a user interface on a kiosk device.

FIG. 15 depicts another embodiment of a user interface on a kiosk device.

FIG. 16 depicts another embodiment of a user interface on a kiosk device.

FIG. 17 depicts an embodiment of another user interface on a kiosk device.

FIG. 18 is a block diagram that depicts a generalized processing architecture that can be used to implement the routing system and other systems and components discussed herein.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein describe a customer reward program. The rewards offered to a customer include, but are not limited to rewards such as cash back and points-based rewards. Some embodiments implement the customer reward program via methods that include application software running on one or more computing devices that include, but are not limited to laptop computers, desktop computers, mobile devices, tablet computers, or any combination of processing devices capable of connecting to a public network such as the Internet. Any combination of these computing devices may be in used by the customer or the merchant as a part of the customer reward program. In other embodiments, the implementation of the customer reward program is done independently of and without any interaction with the merchant point-of-sale device. Some embodiments of the systems and methods described herein use a cloud-based computing architecture that includes a server and a database, to implement at least a portion of the customer reward program architecture.

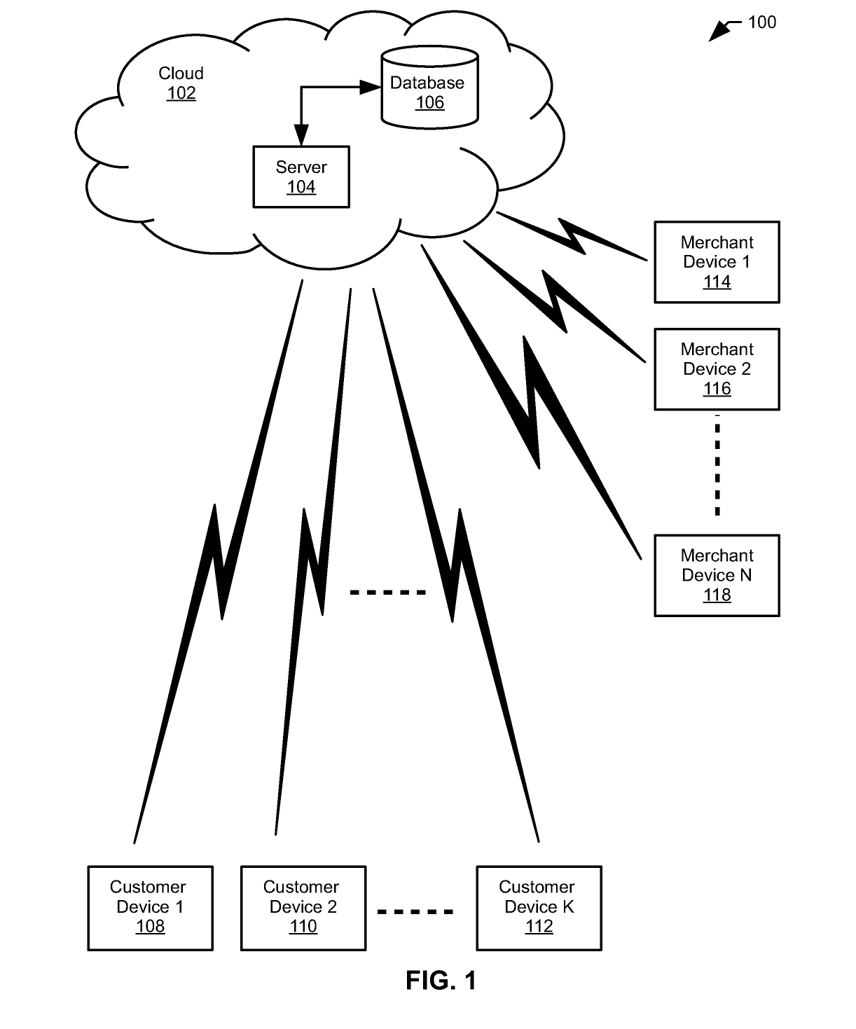

FIG. 1 is a block diagram 100 depicting an embodiment that includes multiple customers and multiple merchants. In one embodiment, a server 104 is interfaced with a database 106. In some embodiments, both server 104 and database 106 are included within a cloud environment 102, wherein the term “cloud” is used to refer to, for example, cloud computing and cloud storage systems. Customer device 1 108, customer device 2 110, through customer device K 112 independently communicate with server 104. Customer device 1 108, customer device 2 110, through customer device K 112 are computing devices capable of displaying information to a user and receiving input from the user. In some embodiments, customer device 1 108, customer device 110, through customer device K 112 may be any combination of laptop computers, desktop computers, mobile devices, tablet computers or any computing device capable of connecting to a public network such as the Internet. In other embodiments, customer device 1 108, customer device 110, through customer device K 112 independently run application software that allow these devices to independently communicate with database 106 via server 104. In some embodiments, database 106 stores customer accounts for the customers associated with customer device 1 108, customer device 110, through customer device K 112, wherein customer account information for each customer may include reward information associated with the purchase history of that customer. Customers associated with customer device 1 108, customer device 110, through customer device K 112 can independently access their respective customer account information stored on database 106 via customer device 1 108, customer device 110, through customer device K 112 respectively. In some embodiments, a customer device runs application software that provides a user interface for a customer to access their customer information stored on database 106.

In some embodiments, merchant device 1 114, merchant device 2 116, through merchant device N 118, independently communicate with server 104. Merchant device 1 114, merchant device 2 116, through merchant device N 118 are computing devices capable of displaying information to a user and receiving input from the user. In some embodiments, merchant device 1 114, merchant device 2 116, through merchant device N 118 may be any combination of laptop computers, desktop computers, mobile devices, tablet computers or any computing device capable of connecting to a public network such as the Internet. In other embodiments, merchant device 1 114, merchant device 2 116, through merchant device N 118 independently run application software that allows these devices to independently communicate with database 106 via server 104. In some embodiments, merchant device 1 114, merchant device 2 116, through merchant device N 118 can independently access one, some or all of the customer accounts stored on database 106. In some embodiments, a merchant device runs application software that provides a user interface for a merchant to access information associated with one or more customers stored on database 106.

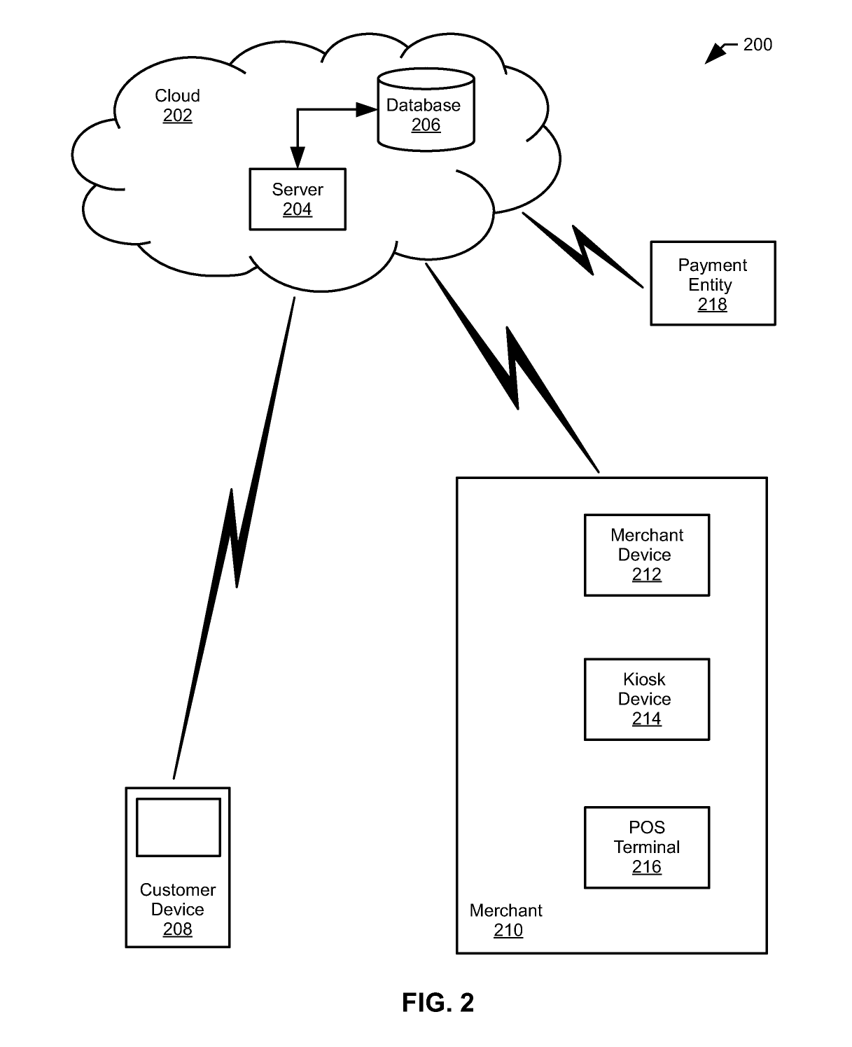

FIG. 2 is a block diagram 200 depicting an embodiment that includes a payment entity in addition to a customer device and a merchant. In one embodiment, server 204 is interfaced with database 206. In some embodiments, both server 204 and database 206 are included within cloud environment 202. Customer device 208 independently communicates with server 204. Customer device 208 is a computing device capable of displaying information to a user and receiving input from a user. In some embodiments, customer device 208 may be a laptop computer, a desktop computer, a mobile device, a tablet computer, or any computing device capable of connecting to a public network such as the Internet. In other embodiments, customer device 208 runs application software that allows this device to communicate with database 206 via server 204. In some embodiments, database 206 stores a customer account for the customer associated with customer device 208, wherein the customer account information may include reward information associated with the purchase history of the customer. The customer associated with customer device 208 can access their customer account information stored on database 206 via customer device 208. In some embodiments, a customer device runs application software that provides a user interface for the customer to access their customer information stored on database 206. In some embodiments, the customer device 208 may communicate with server 204 via a service such as the short message service (SMS). In some embodiments, the customer device 208 may be a smartphone without a data plan. In other embodiments, the customer device 208 may be a mobile device without the features of a smartphone (sometimes referred to as a “dumb phone”). In other embodiments, the customer device 208 may be a plastic card with a unique customer ID. For example, a card with a magnetic stripe, or a plastic fob with near-field connectivity such as RFID, may be used as the customer device 208.

In some embodiments, merchant 210 includes merchant device 212, kiosk device 214 and POS terminal 216, wherein the term POS is used to denote the phrase “point-of-sale.” Merchant device 212 and kiosk device 214 are computing devices capable of displaying information to a user and receiving input from a user. In some embodiments, merchant device 212 and kiosk device 214 can be any combination of laptop computers, desktop computers, mobile devices, tablet computers or any computing device capable of connecting to a public network such as the Internet. In some embodiments, POS terminal 216 may be a standard point-of-sale terminal. In other embodiments, the POS terminal 216 may be a cash register. In some embodiments, merchant device 212 and kiosk device 214 can independently communicate with server 204. In other embodiments, merchant device 212 and kiosk device 214 independently run application software that allows these devices to independently communicate with database 206 via server 204. In some embodiments, merchant device 212 and kiosk device 214 can independently access one or more customer accounts stored on database 206, including the customer account of the customer associated with consumer device 208. In other embodiments, the application software running on merchant device 212 may be integrated into the POS terminal 216, in which case the functions of the merchant device are performed by the POS terminal 216 in addition to the other functions of the POS terminal 216.

Some embodiments include payment entity 218 which also communicates with database 206 via server 204. In some embodiments, the payment entity 218 may be a bank or a financial institution that processes and honors cash back payment requests. In other embodiments, the payment entity 218 may collect payments from merchants using methods that include, but are not limited to, credit card processing services. In other embodiments, the payment entity may add or subtract funds from customer reward accounts associated with the payment entity.

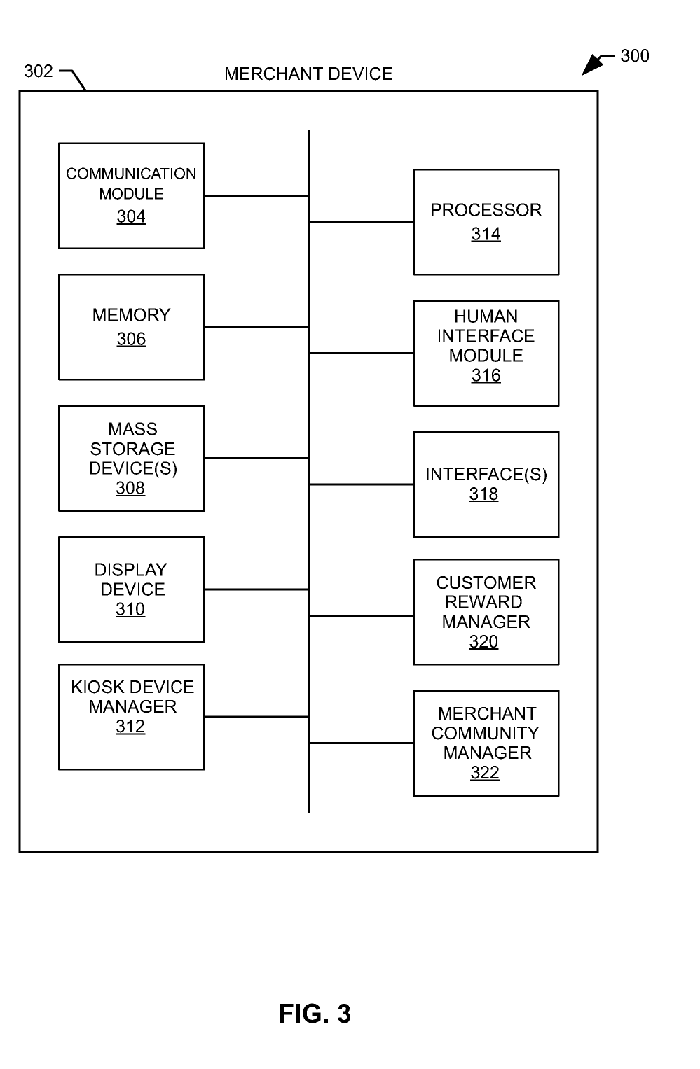

FIG. 3 is a block diagram 300 depicting an embodiment of the architecture of a merchant device. In some embodiments, a merchant device 302 may include communication module 304 that allows the merchant device 302 to communicate with other external devices by methods that include communication via the Internet. Memory 306 including, but not limited to, any combination of random access memory (RAM), read-only memory (ROM) and flash memory, is used to store data required by the merchant device 302. Mass storage device 308, which may be a hard disk drive, is used for data storage. Display device 310 may include a device such an LCD display or an OLED display for presenting a user interface, and other information, to a user of the merchant device 302. Merchant device 302 may also include merchant kiosk manager 312 that is used to manage the operations associated with a kiosk device such as 214. Merchant device 302 may also include processor 314, and human interface module 316. Processor 314 performs any number of operations and activities, such as those discussed herein. Human interface module 316 may include human interface methods including, but not limited to, audio-visual signals, haptic feedback, touchscreen input, voice commands and so on. Interface(s) 318 is used to interface with one or more external devices. Customer reward manager 320 is associated with managing the customer rewards based on the customer's transaction with the merchant. Merchant community manager 322 is associated with managing the local merchant network, where a group of merchants collaboratively advertise their goods or services on each other's kiosk device.

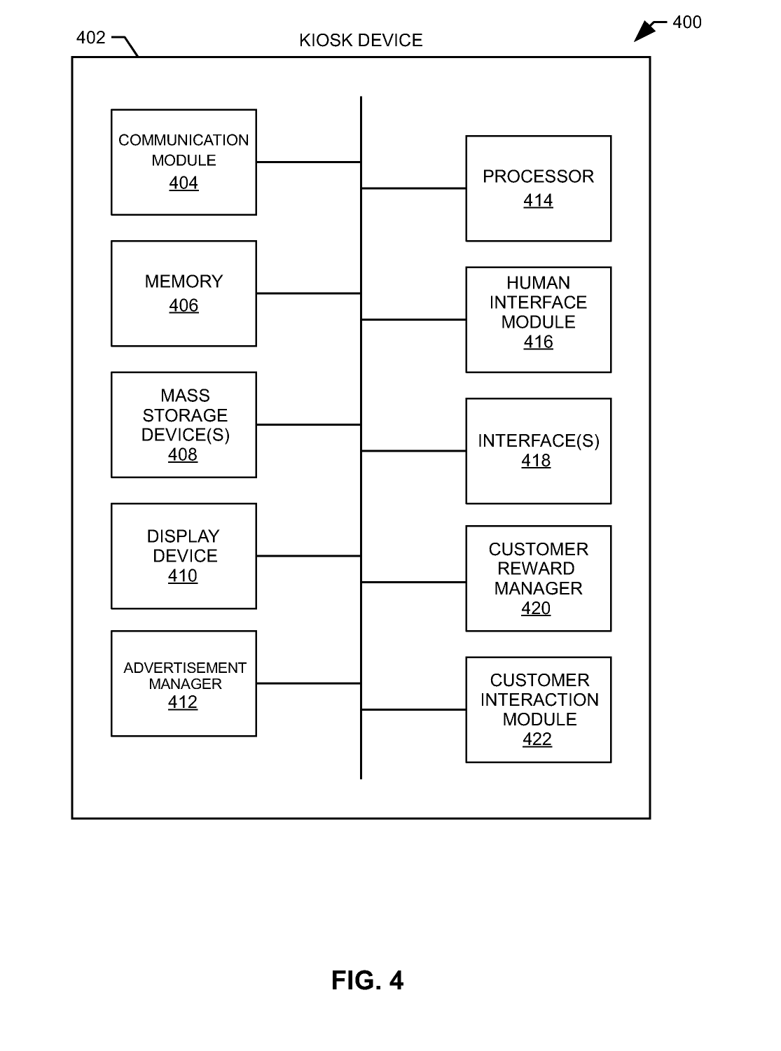

FIG. 4 is a block diagram 400 depicting an embodiment of the architecture of a kiosk device. In some embodiments, a kiosk device 402 may include communication module 404 that allows the kiosk device 402 to communicate with other external devices by methods that include communication via the Internet. Memory 406 including, but not limited to, any combination of random access memory (RAM), read-only memory (ROM) and flash memory, is used to store data required by the kiosk device 402. Mass storage device 408, which may be a hard disk drive, is used for data storage. Display device 410 may include a device such an LCD display or an OLED display for presenting a user interface and other information to a user of the kiosk device 402. Kiosk device 402 may also include advertisement manager 412 that is used to manage the different advertisements displayed on kiosk device 402. In some embodiments, the advertisements displayed on kiosk device 402 are some combination of advertisements from the merchant associated with kiosk device 402, as well as advertisements from other merchants. Kiosk device 402 may also include processor 414, and human interface module 416. Processor 414 performs any number of operations and activities, such as those discussed herein. Human interface module 416 may include human interface methods including but not limited to audio-visual signals, haptic feedback, touchscreen input, voice commands and so on. Interface(s) 418 is used to interface with one or more external devices. Customer reward manager 420 is associated with managing the customer rewards based on the customer's transaction with the merchant. Customer interaction module 422 is associated with interfacing with a customer, including handling login information for customer accounts, as well as retrieving and presenting customer account information to the customer.

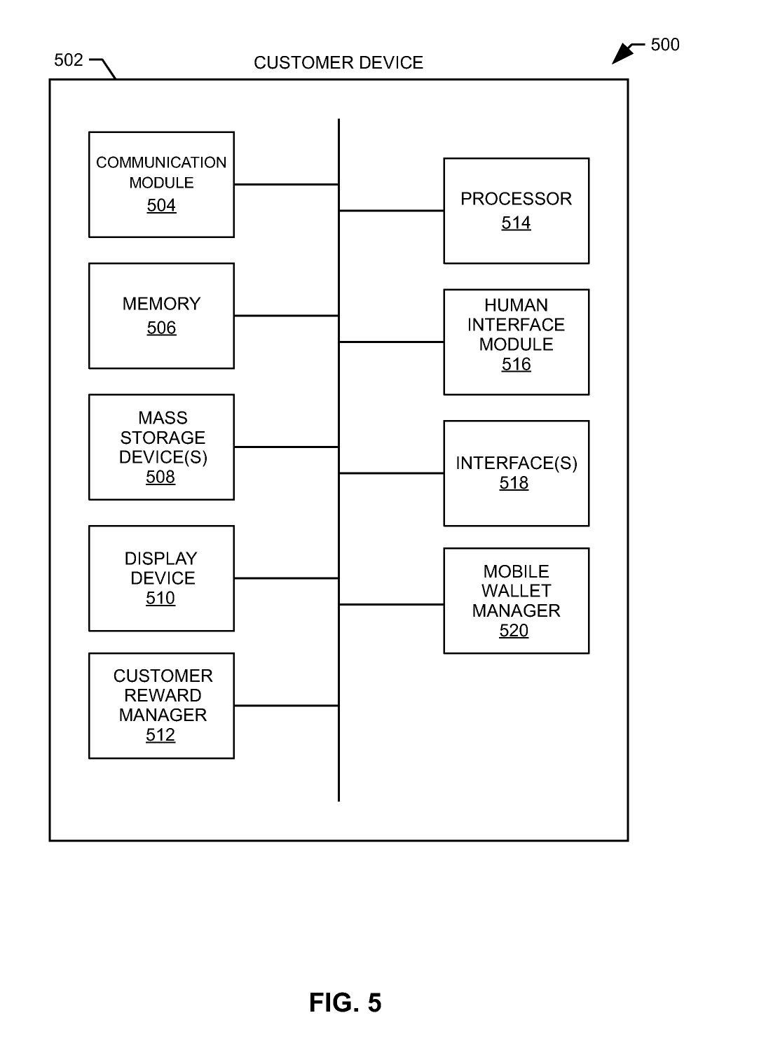

FIG. 5 is a block diagram 500 depicting an embodiment of the architecture of a customer device. In some embodiments, a customer device 502 may include communication module 504 that allows the customer device 502 to communicate with other external devices by methods that include communication via the Internet. Memory 506 including, but not limited to, any combination of random access memory (RAM), read-only memory (ROM) and flash memory, is used to store data required by the customer device 502. Mass storage device 508, which may be a hard disk drive, is used for data storage. Display device 510 may include a device such an LCD display or an OLED display for presenting a user interface and other information to a user of the Customer device 502. Customer reward manager 512 is associated with managing the customer rewards based on the customer's transaction with the merchant. Customer device 502 may also include processor 514, and human interface module 516. Processor 514 performs any number of operations and activities, such as those discussed herein. Human interface module 516 may include human interface methods including but not limited to audio-visual signals, haptic feedback, touchscreen input, voice commands and so on. Interface(s) 518 is used to interface with one or more external devices. Mobile wallet manager 520 is used to manage the digital wallet of the customer, wherein the digital wallet is used by the customer to make payments for goods and/or services purchased from the merchant. The digital wallet may also store reward points or reward currency associated with the user's reward account.

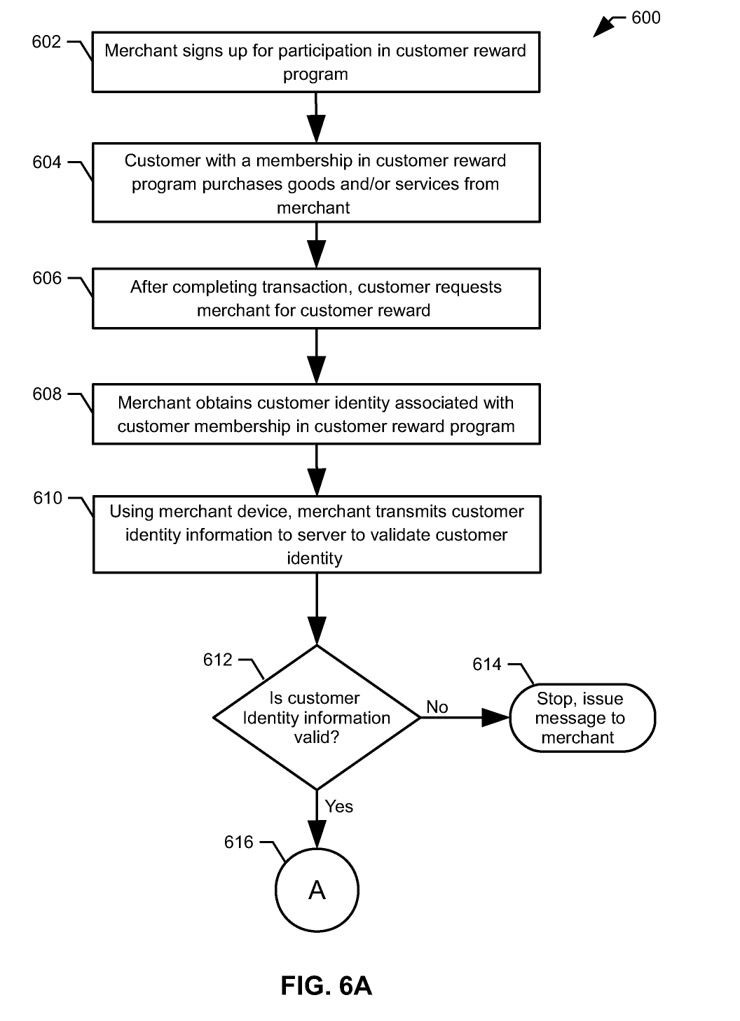

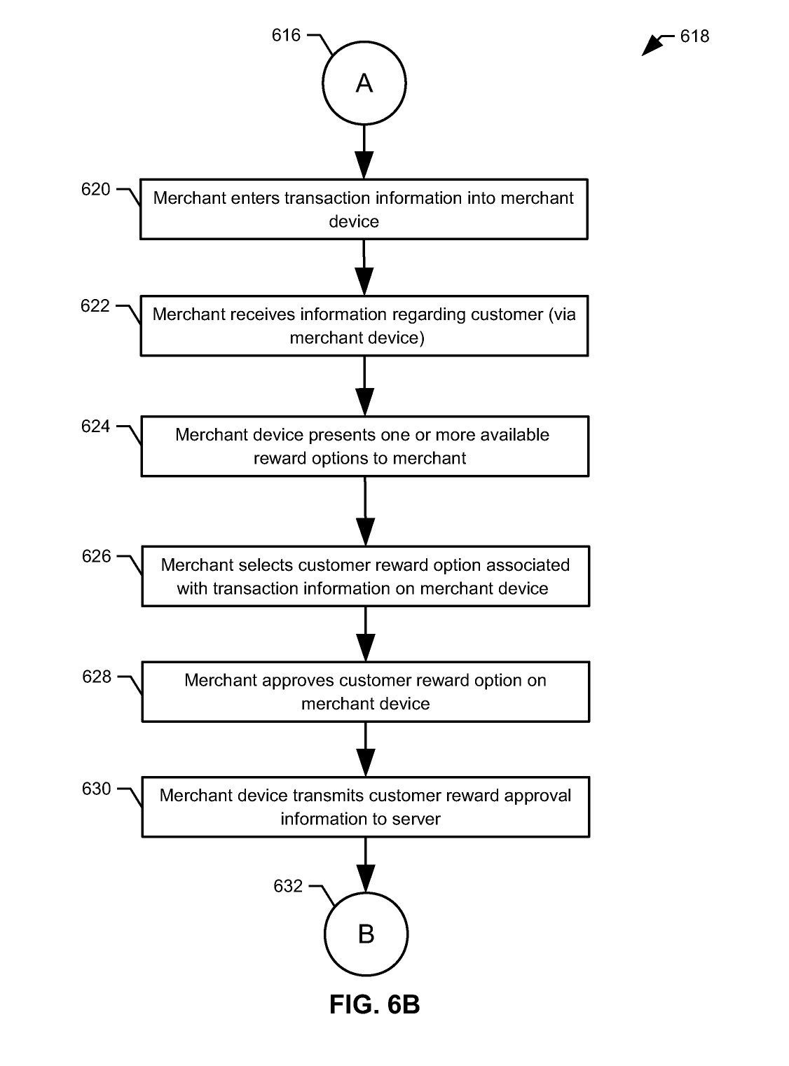

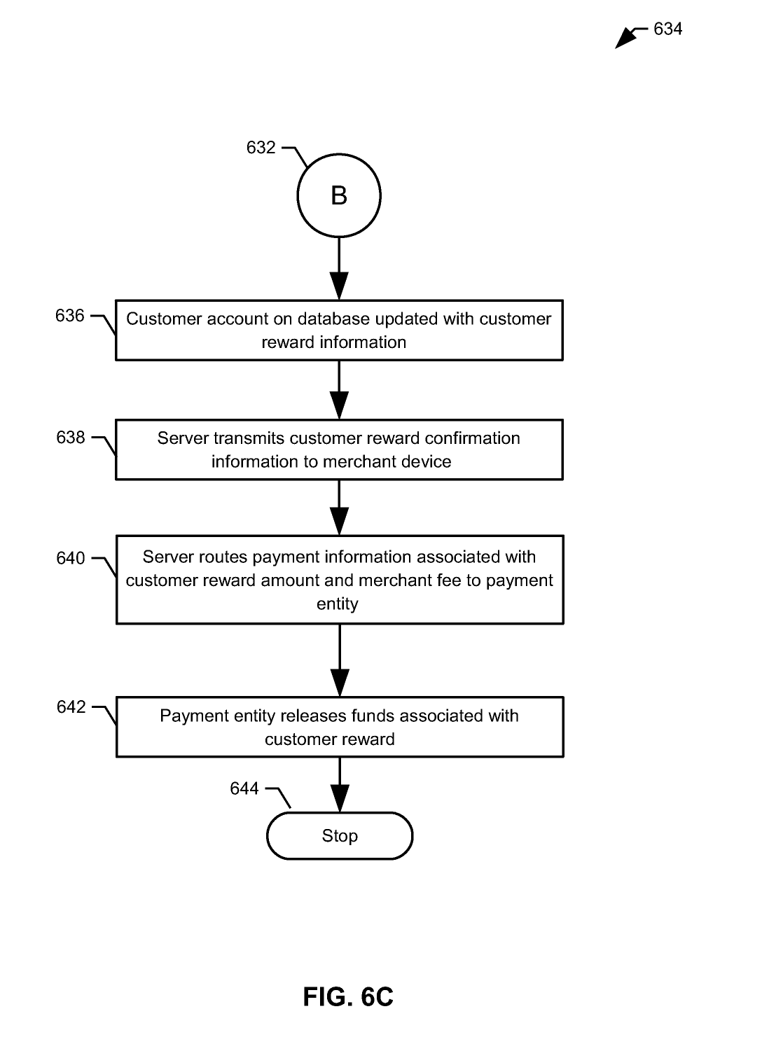

FIG. 6A represents a flow diagram 600 depicting an embodiment of a method for issuing a customer reward. At 602, a merchant signs up for participation in a customer reward program. In some embodiments, the customer reward program charges a participating merchant a fee per customer transaction. At 604, a customer with a membership in the customer reward program purchases goods and/or services from the merchant. At 606, after completing the transaction, the customer requests the merchant for the customer reward. At 608, the merchant obtains the customer identity associated with the customer membership in the customer reward program. Next, at 610, the merchant, using the merchant device, transmits the customer identity information to the server to validate the customer identity. At 612 the server checks, based on information from the database, to see if the customer identity information is valid. If the customer identity is not valid, then at 614, the system issues a message to the merchant, and the method terminates. At this point, the merchant can alert the customer to the failed login attempt, and the customer can try to log in again, attempt to recover a lost login ID or password, or if the customer does not have a membership in the customer reward program, the customer can sign up for a membership in the customer reward program. At 612, if the customer identity is valid, then the method proceeds to 616, designated as A, with a continued description in the next figure.

FIG. 6B represents a flow diagram 618 which is a continuation of the flow diagram of FIG. 6A. At 616, A, the method continues from FIG. 6A, and proceeds to 620, where the merchant enters transaction information into the merchant device. At 622, the merchant receives information regarding the customer via the merchant device, wherein the customer information includes the customer account information. In some embodiments, the customer account information includes the customer's personal information, including but not limited to the customer's name, the customer's physical address, the customer's contact information and so on. In other embodiments, the customer account information may also include the customer status such as whether the customer is enrolled in the customer reward program, how long the customer has been enrolled in the customer reward program, the reward balance and so on. The customer account information may also include warning flags such as fraud advisories. In some embodiments, customers may be awarded badges and statuses, such as gold, silver and bronze, based on their shopping histories. This data may also be included as a part of the customer account information.

Next, at 624, the merchant device presents one or more available rewards options to the merchant. At 626, the merchant selects, on the merchant device, the customer reward option associated with the transaction information. In an alternate embodiment, the merchant may directly skip steps 620 through 624, proceeding from step 616 straight to step 626. In this embodiment, the merchant selects, on the merchant device, the customer reward option associate with the transaction information at 626, directly after verifying a valid customer identity at 612. At 628, the merchant approves the customer reward option on the merchant device. At 630, the merchant device transmits customer reward approval information to the server. The method then proceeds to 632, designated as B, with a continued description in the next figure.

FIG. 6C represents a flow diagram 634 which is a continuation of the flow diagram of FIG. 6B. At 632, B, the method continues from FIG. 6B, and proceeds to 636, where the server updates the customer account on the database with the customer reward information with data may include the customer's reward amount balance and history. At 638, the server transmits the customer reward information to the merchant device. Next, at 640, the server routes the payment information associated with the customer reward amount and merchant fee to the payment entity. At 642, the payment entity releases the funds associated with the customer reward. Note that steps 640 and 642 are only relevant in the event that the customer reward is a cash back reward. If the customer reward is not a cash back reward, then steps 640 and 642 are not implemented by the method. Finally, the method stops at 644.

In some embodiments, the merchant device may further be configured to process returns and undo transactions. For example, if a customer enrolled in the customer reward program wishes to return a purchased item for which the customer has received a customer reward, the merchant device can be configured with an option for the merchant to revert the customer reward posted to the customer account. Other embodiments may include the merchant deploying multiple merchant devices for use in, for example, larger stores. In these embodiments, each merchant device may have a unique identification number or code that allows the independent use of these merchant devices by, for example, multiple employees of the merchant.

In other embodiments, where a customer might not remember their customer identity, the merchant device may print a machine-readable code as a temporary customer ID. In certain embodiments, the temporary customer ID may be in the form of pre-printed, machine-readable tokens. In other embodiments, the machine-readable code is a barcode, and the merchant device may include a barcode scanner to read in the temporary customer ID. In still other embodiments the machine-readable code is a QR (Quick Response) code, and the merchant device may include a QR code scanner to read in the temporary customer ID via a QR code.

In some embodiments, the merchant reads in the temporary customer ID using the merchant device, and associates the customer reward with the temporary customer ID, which is stored on the database 106. The temporary customer ID may be included in the customer receipt. The customer, in possession of the temporary customer ID, can log into their account (or create a new user account) at a later time and claim the customer reward by associating the temporary customer ID with their account.

In some embodiments, the customer reward program may include additional customer rewards given directly to the customer by the customer reward program, independently of the customer rewards given to the customer by a merchant participating in the customer reward program. In particular embodiments, the customer rewards given directly to the customer by the customer reward program (e.g., by an entity managing the customer reward program) independently of the merchant participating in the customer reward program may depend on customer spending. For example, a customer may receive a higher number of customer rewards given directly to the customer by the customer reward program if they spend more at merchants that participate in the customer reward program. This prevents, for example, a merchant participating in the customer reward program, from offering the customer a reward that is separate from the customer reward program, while not updating the customer account with the transaction history, in order to avoid paying the merchant fees to the customer reward program. For example, if the customer reward for a specific transaction is a cash back amount of $5.00, and the associated transaction fee for a merchant participating in the customer reward program is $6.25, then the merchant may, in order to reduce their out-of-pocket expenses, directly give the customer a cash rebate of $5.00, and save money by not having to pay the customer reward program the fee of $6.25. By offering customer rewards that are independent of the transaction-based customer rewards that are given by a merchant participating in the customer reward program, the customer reward program greatly reduces the chance of such dealings between the customer and a merchant participating in the customer reward program. Thus, the customer will be more motivated in insisting that the merchant participating in the customer reward program legitimately credit their customer account in order to avail of the additional benefits offered by the customer reward program to the customer.

The customer reward program may also include a referral program, wherein a customer with an existing membership in the customer reward program receives additional rewards when referring a new member to the customer reward program. In some embodiments, the customer reward program may include a customer-to-customer referral bonus customer reward. In these embodiments, a customer with a membership in the customer reward program (referred to herein as the “referring customer”) refers a customer who is not a member in the customer reward program (referred to herein as a “referred customer”). For example, the referring customer gets a bonus customer reward when the referred customer signs up for the customer reward program. In particular embodiments, the referred customer, on signing up for the customer reward program, may get a special reward from the customer reward program. In some embodiments, the bonus customer reward given to the referring customer by the customer reward program may be a one-time reward. In other embodiments, the bonus customer reward may be a time-limited offer, wherein the referring customer is entitled to bonus rewards on one or more purchases made at merchants participating in the customer reward program, during a specific time duration.

In other embodiments, the bonus customer reward may take the form of bonus rewards to the referring customer for a fixed number of subsequent purchases. Other embodiments may include both the time-limited and fixed purchase quantity bonus reward implementation. Other embodiments may implement multi-tier referral programs. For example, if a first referring customer refers a first referred customer who successfully signs up for the customer reward program, and then the first referred customer becomes a referring customer for a second referred customer who also successfully signs up for the customer reward program, then the customer reward program may offer bonus customer rewards to both the first referring customer and the first referred customer.

Some embodiments may include the customer reward program issuing customer rewards in the form of gift cards, wherein the gift cards may be physical gift cards. In other embodiments, the gift cards may be electronic gift cards. Gift cards as issued by the customer reward program may be redeemed by the customer, for example, at merchants that participate in the reward program. Other embodiments may include the customer reward program issuing customer rewards in the form of gift certificates, wherein the gift certificates may be physical gift certificates. In other embodiments, the gift certificates may be electronic gift certificates. Gift certificates as issued by the customer reward program may be redeemed by the customer, for example, at merchants that participate in the reward program. Other embodiments may include the customer reward program issuing customer rewards in the form of physical coupons. Still other embodiments may include the customer reward program issuing customer rewards in the form of electronic coupons. Coupons as issued to a customer by the customer reward program may be redeemed by a customer, for example, at merchants that participate in the reward program.

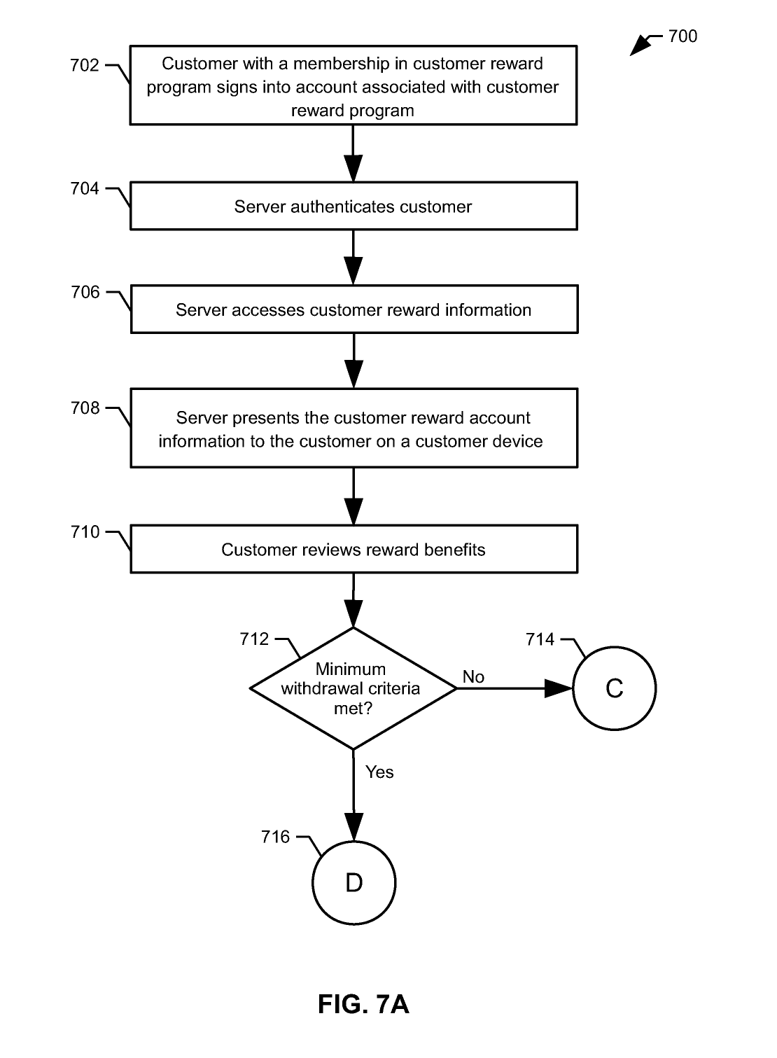

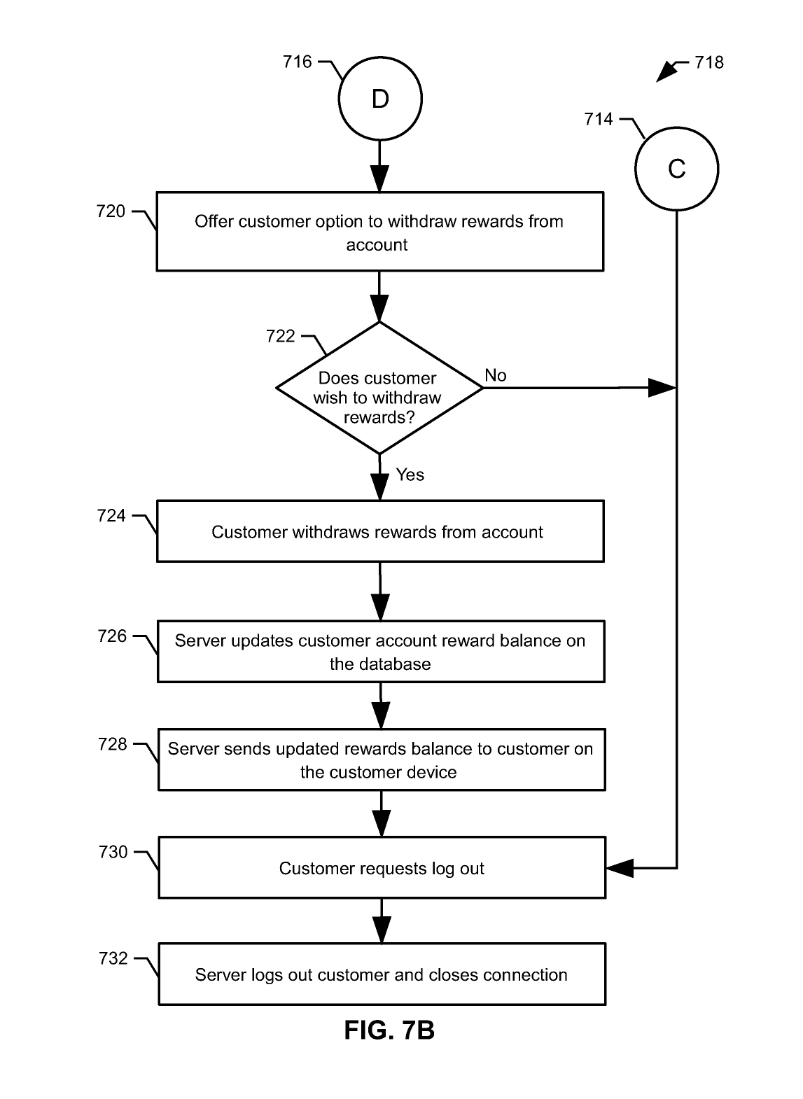

FIG. 7A represents a flow diagram 700 depicting an embodiment of a method for reward withdrawal by a customer. At 702, a customer with a membership in a customer reward program signs into an account associated with the customer reward program. At 704, the server authenticates the customer. Next, at 706, the server accesses the customer reward information stored on the database. At 708, the server presents the customer reward account information to the customer on a customer device. At 710, the customer reviews the reward benefits. At 712, the method checks to determine whether the minimum withdrawal criteria associated with the customer reward program are met. If the minimum withdrawal criteria associated with the customer reward program are not met, then the method proceeds to 714, designated as C, with a continued description in the next figure. If the minimum withdrawal criteria associated with the customer reward program are met, then the method proceeds to 716, designated as D, with a continued description in the next figure.

FIG. 7B represents a flow diagram 718 which is a continuation of the flow diagram of FIG. 7A. Continuing from the description of the previous figure, if the method is at 714 (C), then the method proceeds to 730, where the customer requests to be logged out, and then to 732, where the server logs out the customer and closes the connection. If the method is at 716 (D), then the method proceeds to 720, where the method offers the customer to withdraw rewards from the customer account. Next, at 722, the methods checks to determine whether the customer wishes to withdraw rewards. If not, then the method proceeds to 730, where the customer requests to be logged out, and then to 732, where the server logs out the customer and closes the connection. If the customer wishes to withdraw rewards from the account, the method proceeds to 724, where the customer withdraws rewards from the account. Next, at 726, the server updates the customer account balance on the database. At 728, the server sends the updated rewards balance to the customer on the customer device. Finally, at 730, the customer requests to be logged out, and at 732, the server logs out the customer and closes the connection.

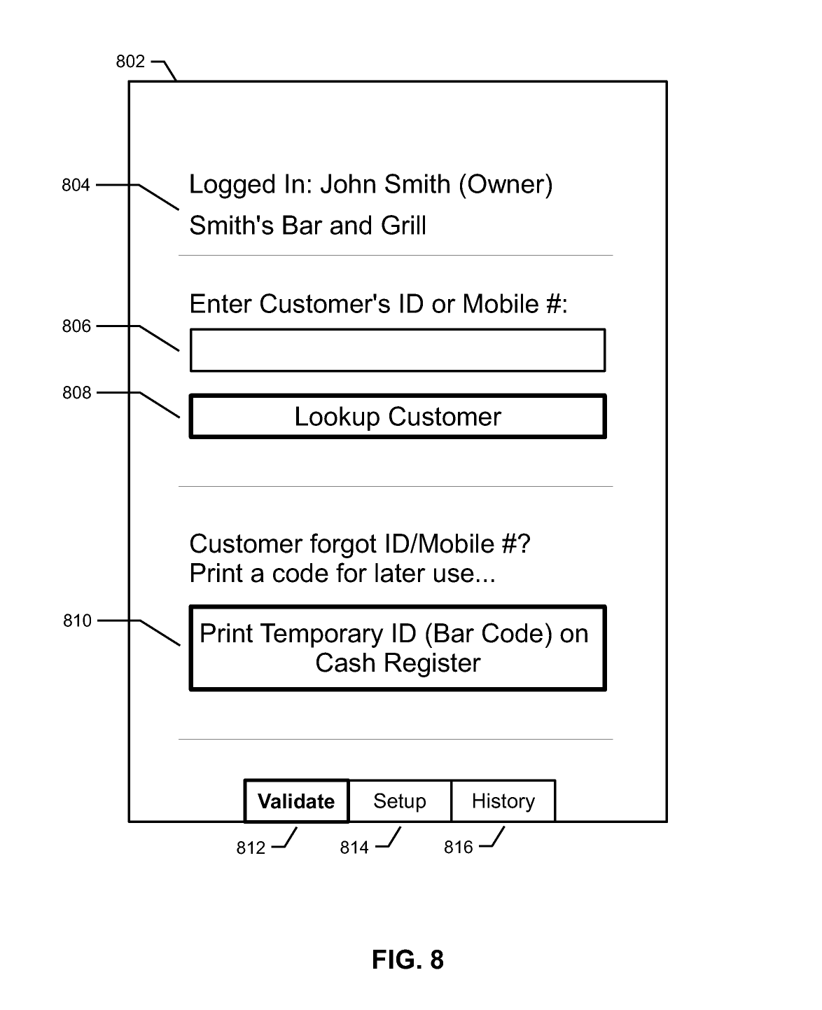

FIG. 8 depicts an embodiment of a user interface 802 on a merchant device. In one embodiment, an application program running on the merchant device presents user interface 802 to the merchant. In this embodiment, user interface 802 allows the merchant to look up the customer identity associated with a customer with membership in the customer reward program in which the merchant participates. User interface 802 includes the identity of the merchant that includes the personal and business names of the merchant, 804. In some embodiments, the merchant is provided with the option of entering a customer's login ID or mobile phone number in text box 806. Button 808 allows the merchant to authorize the server to perform a customer lookup operation. If the customer has forgotten their ID or mobile number, button 810 allows the merchant to print a temporary ID on the cash register. In some embodiments, the temporary ID printed by the merchant is a bar code. User interface 802 also presents to the merchant tab 812 to validate the customer, tab 814 to perform setup operations, and tab 816 to display a history of past merchant interactions with the merchant device. In some embodiments, selecting the tab 812 to validate the customer (as shown in FIG. 8) displays the user interface 802, which allows the merchant to look up the customer identity associated with a customer with membership in the customer reward program in which the merchant participates. In some embodiments, selecting either tab 814 or tab 816 presents a user interface that is different from user interface 802.

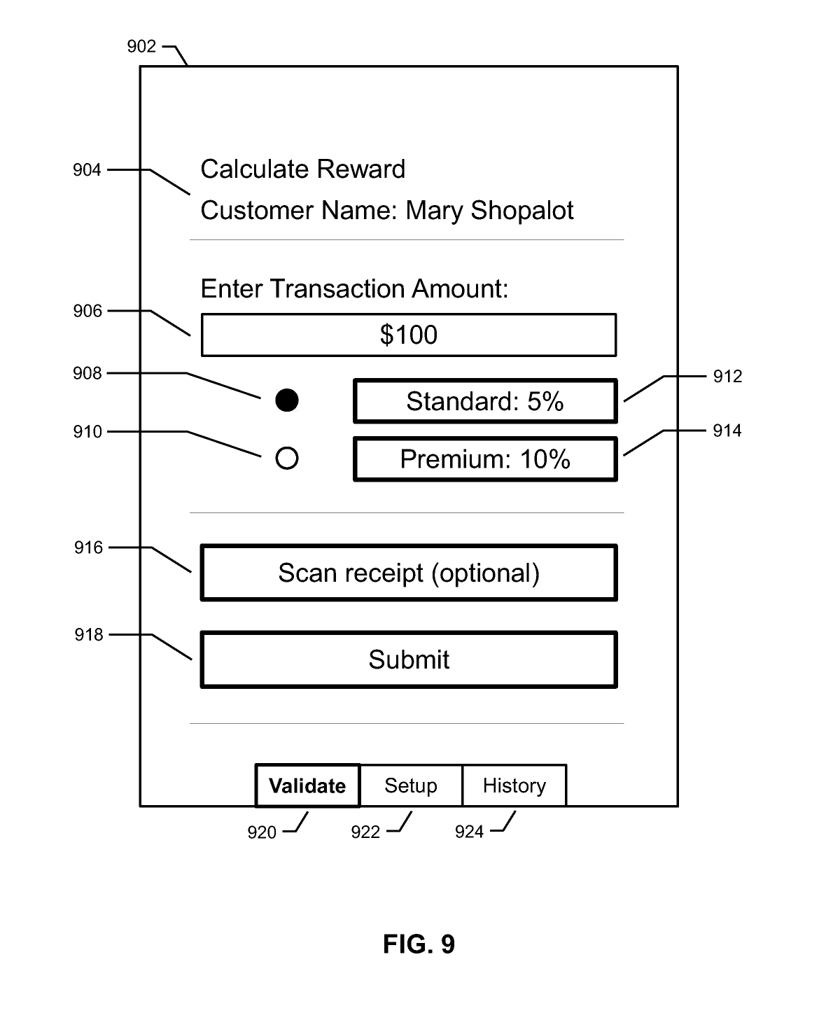

FIG. 9 depicts another embodiment of a user interface 902 on a merchant device. Once a user has been successfully validated by the merchant as discussed in FIG. 8, the merchant is presented with user interface 902 on the merchant device, which allows a user to enter a transaction amount and issue a reward to the customer. This user interface corresponds to the tab 912 to validate the customer, as discussed in the description of FIG. 8. In some embodiments, the merchant is presented with customer information, 904. In some embodiments, the customer reward program can categorize customers in different levels based on, for example, customer shopping history. For example, different customer tier ratings, such as gold, silver and bronze, can be implemented by the customer reward program. This information may be displayed to the merchant on the merchant device via user interface 902. Some embodiments present the merchant with text box 906, in which the merchant enters the transaction amount. In some embodiments, user interface 902 also presents the merchant with multiple reward options. For example, the merchant may be given an option to offer the customer a standard 5% reward 912 selected, for example, via radio button 908. The merchant may also be given an option to offer the customer a premium 10% reward 914 selected, for example, via radio button 910. Alternate embodiments of user interface 902 may allow the merchant to enter any value of the percentage reward they wish to offer to a customer as a part of the customer rewards program. In other embodiments, the rewards to the customer can be directly entered rather than being computed as a percentage of the transaction amount. For example, a merchant might want to reward a regular customer with 100 reward points regardless of the dollar amount of the purchase transaction. In another embodiment that implements a cash back customer reward program, a merchant might want to reward a regular customer with a $10 cash back reward regardless of the dollar amount of the purchase transaction. In still other embodiments, different ranges of transaction values can be associated with different reward values. For example, a dollar amount for a purchase transaction between $10 and $25 can be rewarded with 5 reward points, a dollar amount for a purchase transaction between $25 and $50 can be rewarded with 10 reward points, and so on. In other embodiments, customer rewards can be awarded based on specific items purchased. For example, a merchant may offer greater reward points on clearance items in an attempt to move old merchandise off the shelves.

In some embodiments, the merchant is given the option to scan the sales receipt via button 916. Finally, when all the necessary operations are complete, the merchant can submit the entered information via the submit button 918. In some embodiments, user interface 902 also presents to the merchant tab 920 to validate the customer, tab 922 to perform setup operations, and tab 924 to display a history of past merchant interactions with the merchant device. In some embodiments, selecting the tab 920 to validate the customer (as shown in FIG. 9) displays the user interface 902. In some embodiments, selecting either tab 922 or tab 924 presents a user interface that is different from user interface 902.

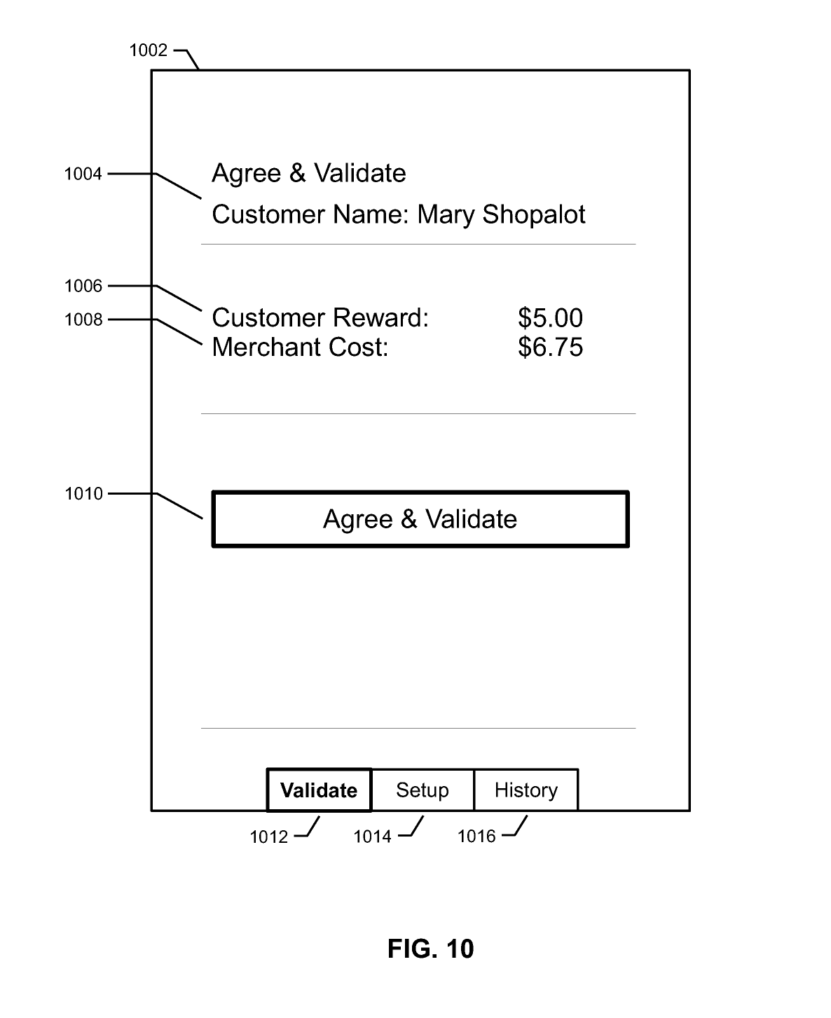

FIG. 10 depicts another embodiment of a user interface 1002 on a merchant device. In some embodiments, user interface 1002 is displayed to the merchant after the merchant presses the button 918 to submit the information entered on the user interface 902 The information presented on user interface 1002 is based on information returned from the server based on the information submitted from the user interface 902. In some embodiments, the information displayed via user interface 1002 on the merchant device includes verification information 1004 for a specific customer. In some embodiments where the customer reward is in the form of cash back, the user interface 1002 may display the cash back amount to the customer 1006. In other embodiments, the user interface 1002 may display the number of reward points earned by the customer. In other embodiments, the provider of the customer reward program may charge the merchant a fee per customer transaction, in which the user interface 1002 may also display the cost to the merchant (the merchant fee) 1008. The Agree & Validate button 1010 enables the merchant to confirm the customer reward to the server. User interface 1002 also presents to the merchant tab 1012 to validate the customer, tab 1014 to perform setup operations, and tab 1016 to display a history of past merchant interactions with the merchant device. In some embodiments, selecting the tab 1012 to validate the customer (as shown in FIG. 10) displays the user interface 1002. In some embodiments, selecting either tab 1014 or tab 1016 presents a user interface that is different from user interface 1002.

In some embodiments that implement cash back rewards, the customer reward program charges the merchant both for both the cash back amount to the customer and the merchant fee. The customer reward program keeps the merchant fee and passes on the cash back reward to the customer. In other embodiments that implement cash back rewards, the customer reward program charges the merchant only for the merchant fee, with the cash back reward being directly transferred to the customer from the merchant.

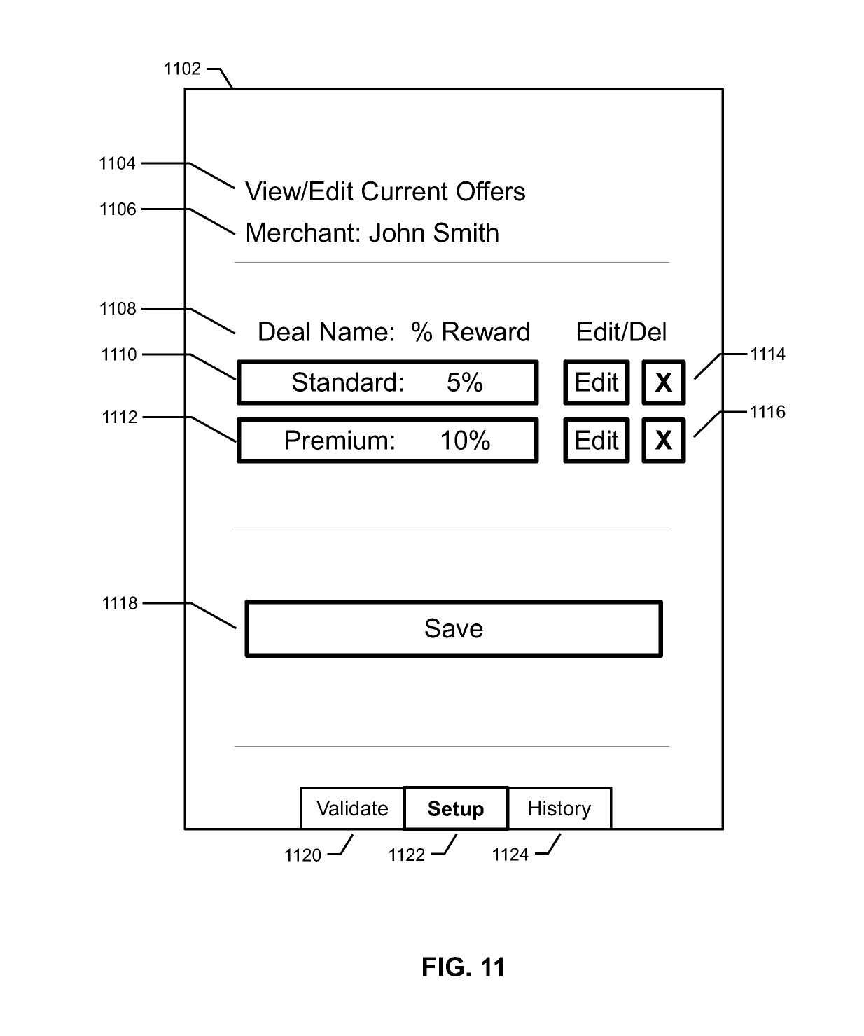

FIG. 11 depicts another embodiment of a user interface 1102 on a merchant device. In one embodiment, the selection of the setup tab 1122 displays user interface 1102 which allows the merchant to make changes to the deals being offered by the merchant as a part of the customer reward program. In some embodiments, validate tab 1120 and history tab 1124 are also provided which, when individually selected by the customer, display user interfaces that are different from each other and from user interface 1102. In some embodiments, user interface 1102 displays a message 1104 that signifies to the merchant that the user interface 1102 allows the merchant to view and, if required, edit the deals being offered by the merchant as a part of the customer reward program. User interface may also display the name of the merchant, 1106. In some embodiments, 1108 is the part of the user interface 1102 where the merchant can edit the deals being offered by the merchant as a part of the customer reward program. For example, a standard reward of 5% 1110 being offered by the merchant can be either edited or deleted 1114. As another example, a premium reward of 10% 1112 can be either edited or deleted 1116. A save button 1118 allows the merchant to save any changes made by the merchant on user interface 1102.

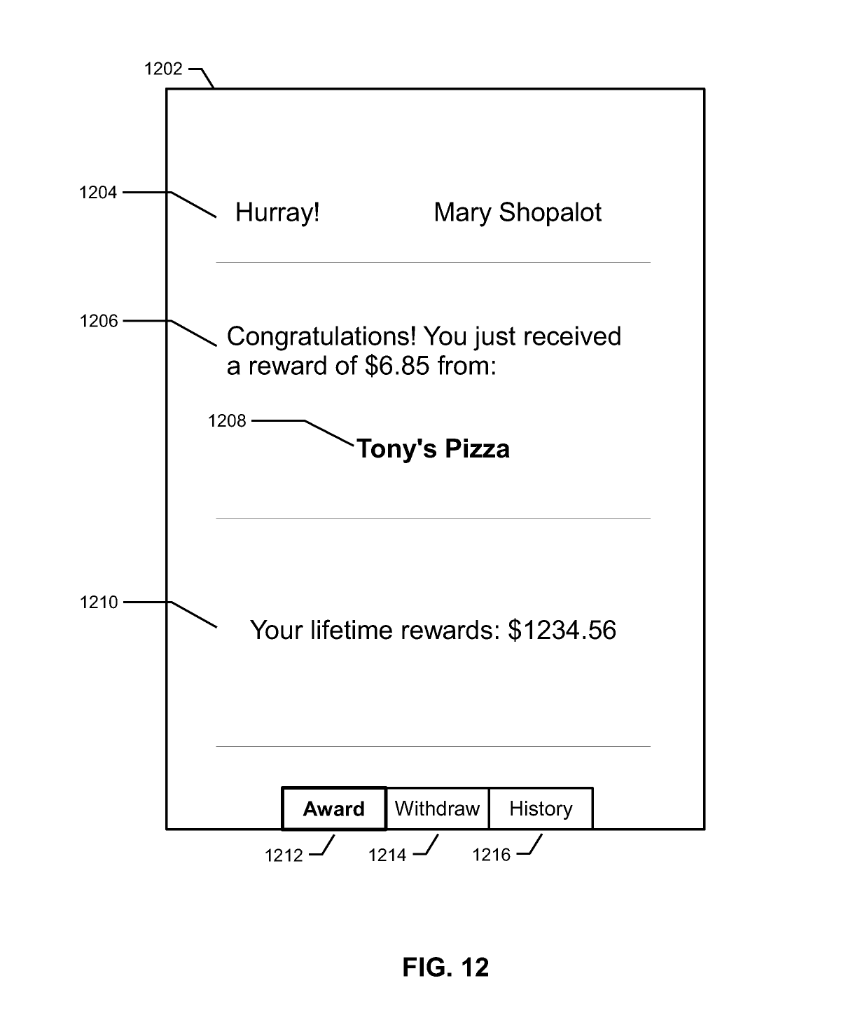

FIG. 12 depicts an embodiment of a user interface 1202 on a customer device. In some embodiments, the selection of award tab 1212 presents user interface 1202 which presents to the customer a customer reward upon the successful completion of an eligible transaction with a merchant that participates in the associated customer reward program. It is important to note that customer access to the different user interfaces on the customer device running the associated application software is possible only after successful customer login and validation on the customer device. In some embodiments, user interface 1202 may present a message to the customer, 1204. In other embodiments, user interface 1202 may present to the customer details of the reward (for example, a cash back amount) 1206. The user interface 1202 may also present the name of the merchant associated with the reward 1208. The rewards earned by the customer for the time the customer has been a part of the customer reward program 1210 may be presented to the customer by user interface 1202. In some embodiments, other than award tab 1212, user interface 1202 may present a withdraw tab 1214, and a history tab 1216. Withdraw tab 1214 and history tab 1216, when individually selected by the customer, present user interfaces that are different from each other, and also different from user interface 1202. Some embodiments may include audiovisual feedback which may include animations or sound effects.

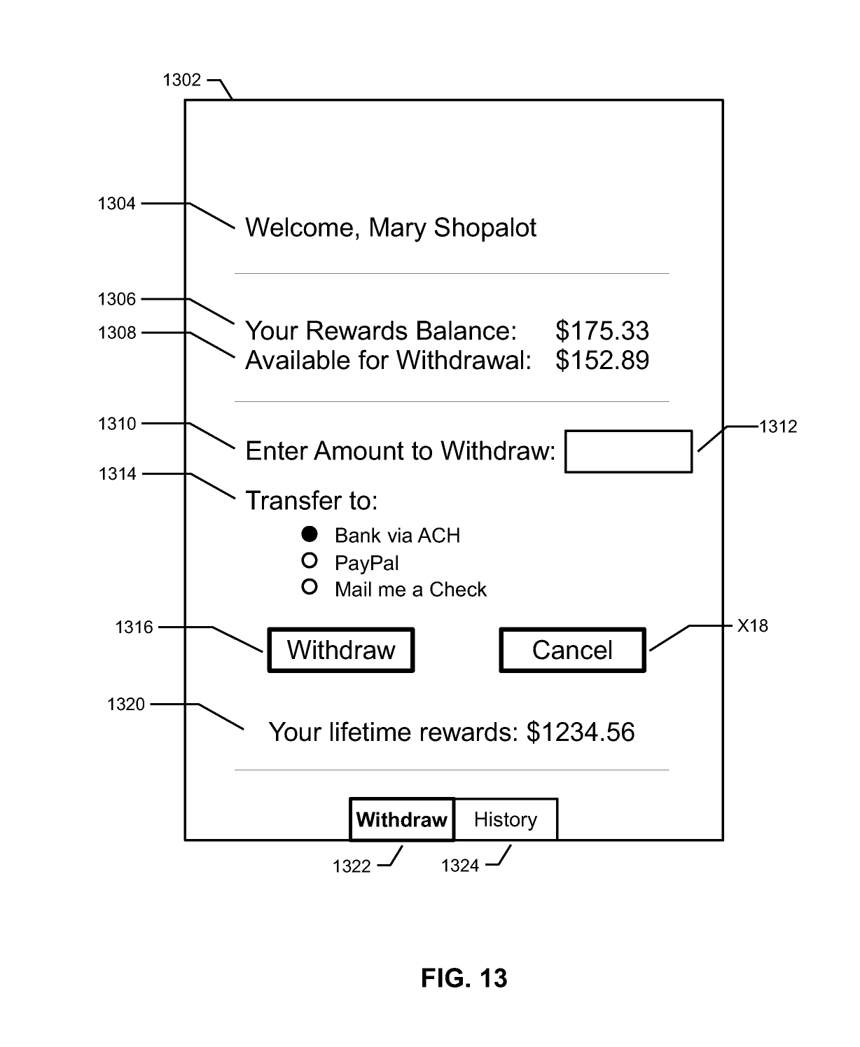

FIG. 13 depicts another embodiment of a user interface 1302 on a customer device. In some embodiments, the selection of withdraw tab 1324 by the customer on the customer device presents user interface 1302 which gives the user the option to use their accrued rewards from a customer reward program. In some embodiments, the accrued rewards may be cash back rewards. In other embodiments, the accrued rewards may be in the form of points. In other embodiments, user interface 1302 presents a greeting message 1304 to the customer. User interface 1302 may also present to the customer the current balance of the accrued rewards 1306, we well as the rewards available for withdrawal 1308. 1310 may present, for example, a message to the customer for the customer to enter the portion of the rewards that the customer wishes to withdraw. In some embodiments, the customer may enter the portion of the rewards that the customer wishes to withdraw via text box 1312. User interface 1302 may also include 1314, providing different options for the customer to withdraw their rewards. Withdraw button 1316 allows the customer to submit the information entered in text box 1312, while cancel button 1318 allows the customer to cancel the transaction. In some embodiments, user interface 1302 may also include a history tab 1326 which, when selected, presents a user interface to the customer that is different from user interface 1302, wherein the user interface corresponding to the selection of history tab 1326 presents a transaction history to the customer.

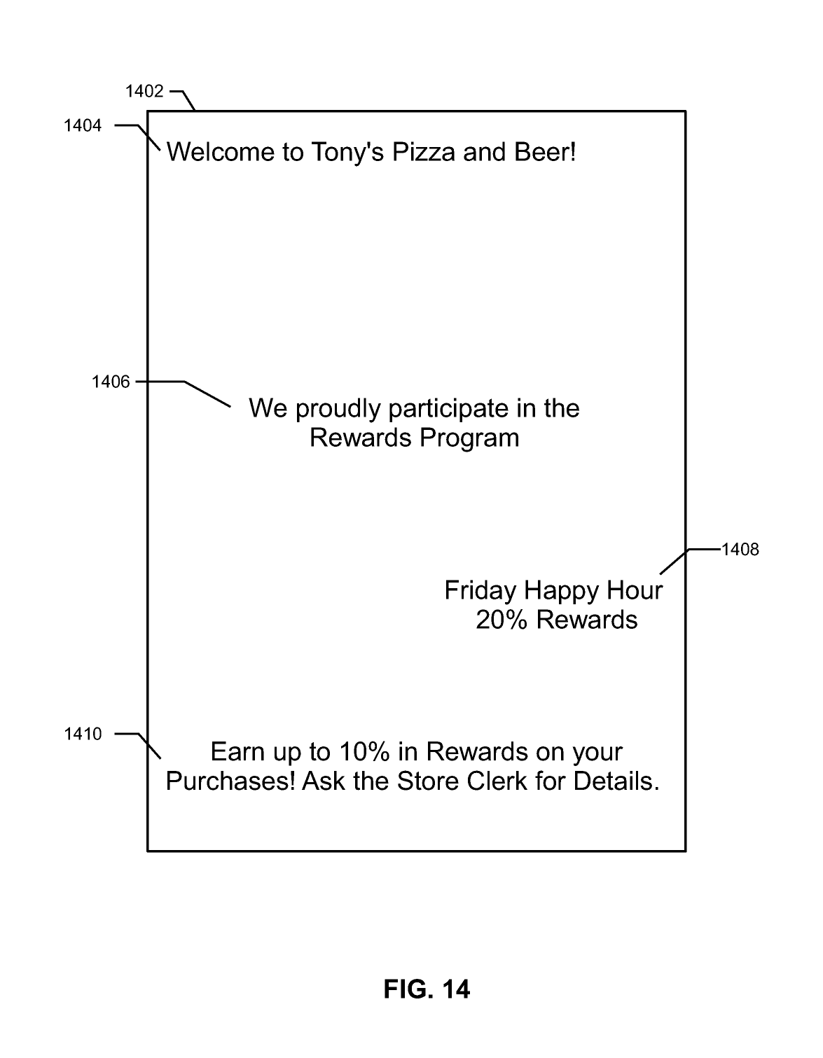

FIG. 14 depicts an embodiment of a user interface 1402 on a kiosk device. In some embodiments, kiosk device presents user interface 1402 that functions as a welcome screen that displays the current offers being offered by the merchant as a part of the customer reward program. In some embodiments, the user interface 1402 may be presented on a tablet device or a computer display monitor at the entrance of the merchant's place of business. In other embodiments, the user interface 1402 displays a welcome message 1404 which includes the name of the merchant or business. In some embodiments, message 1406 provides a confirmation to the customer that the merchant participates in a specific customer reward program. In some embodiments, reward offer 1408 and reward offer 1410 may be presented on user interface 1402.

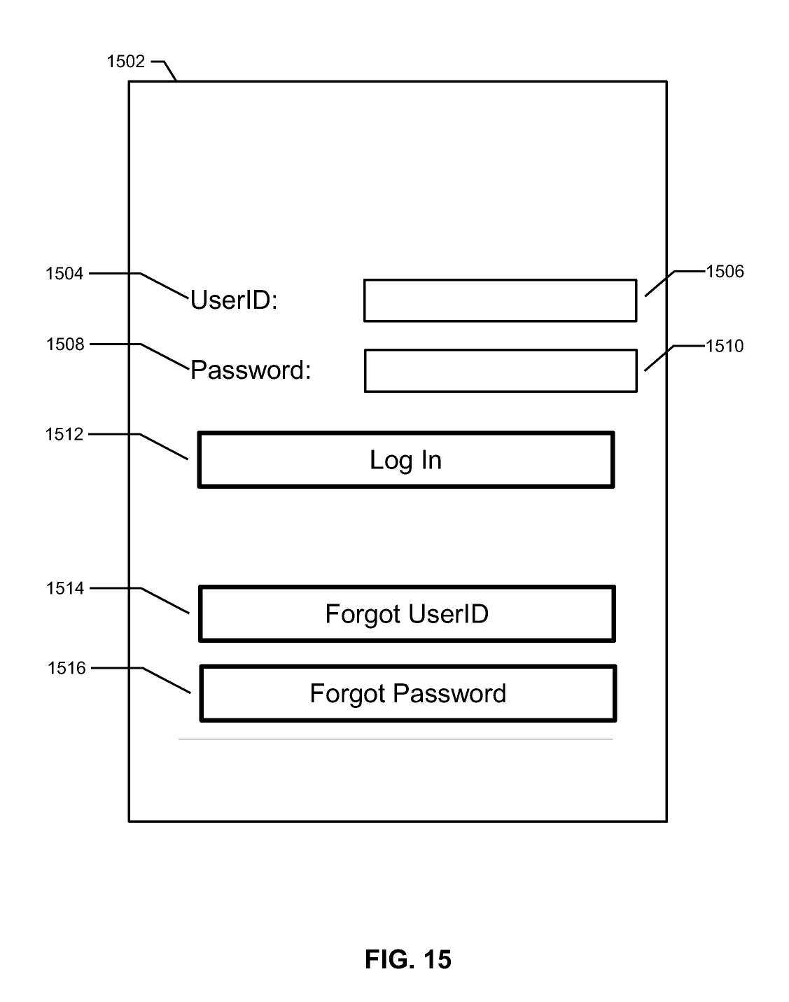

FIG. 15 depicts another embodiment of a user interface 1502 on a kiosk device. In some embodiments, user interface 1502 on a kiosk device allows a customer to login to their customer account associated with the customer reward program. In some embodiments, user interface 1502 presents message 1504 which requests the customer for their user ID. The customer can input their user ID via text box 1506. In some embodiments, user interface 1502 presents message 1508 which requests the customer for their password. The customer can input their password via text box 1510. Log in button 1512 allows a customer to submit their login information to the server for authentication. In the event that the customer has forgotten their user ID, forgot userID button 1514 allows a customer to retrieve their user ID. In the event that the customer has forgotten their password, forgot password button 1516 allows a customer to retrieve their password.

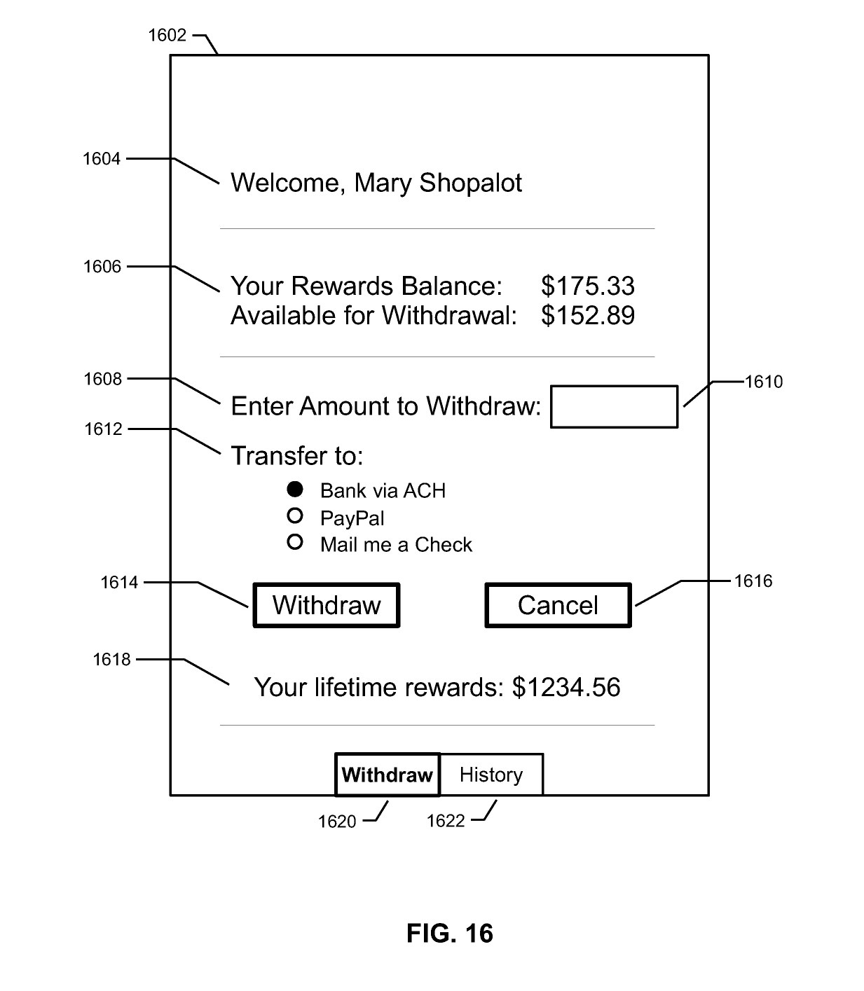

FIG. 16 depicts another embodiment of a user interface 1602 on a kiosk device. In some embodiments, a customer with a customer account associated with a customer reward program can redeem their rewards via the merchant kiosk device. In some embodiments, the selection of withdraw tab 1624 by the customer on the kiosk device presents user interface 1602 which gives the user the option to use their accrued rewards from a customer reward program. In some embodiments, the accrued rewards may be cash back rewards. In other embodiments, the accrued rewards may be in the form of points. In other embodiments, user interface 1602 presents a greeting message 1604 to the customer. User interface 1602 may also present to the customer the current balance of the accrued rewards 1606, we well as the rewards available for withdrawal 1608. 1610 may present, for example, a message to the customer for the customer to enter the portion of the rewards that the customer wishes to withdraw. In some embodiments, the customer may enter the portion of the rewards that the customer wishes to withdraw via text box 1612. User interface 1602 may also include 1614, providing different options for the customer to withdraw their rewards.

In some embodiments, the customer reward program may be implemented to include cash back rewards, in which case the customer may be provided with the option to receive the accumulated cash back rewards balance directly from the merchant. In this case, the merchant functions like an ATM service. Withdraw button 1616 allows the customer to submit the information entered in text box 1612, while cancel button 1618 allows the customer to cancel the transaction. In some embodiments, user interface 1602 may also include a history tab 1626 which, when selected, presents a user interface to the customer that is different from user interface 1602, wherein the user interface corresponding to the selection of history tab 1626 presents a transaction history to the customer.

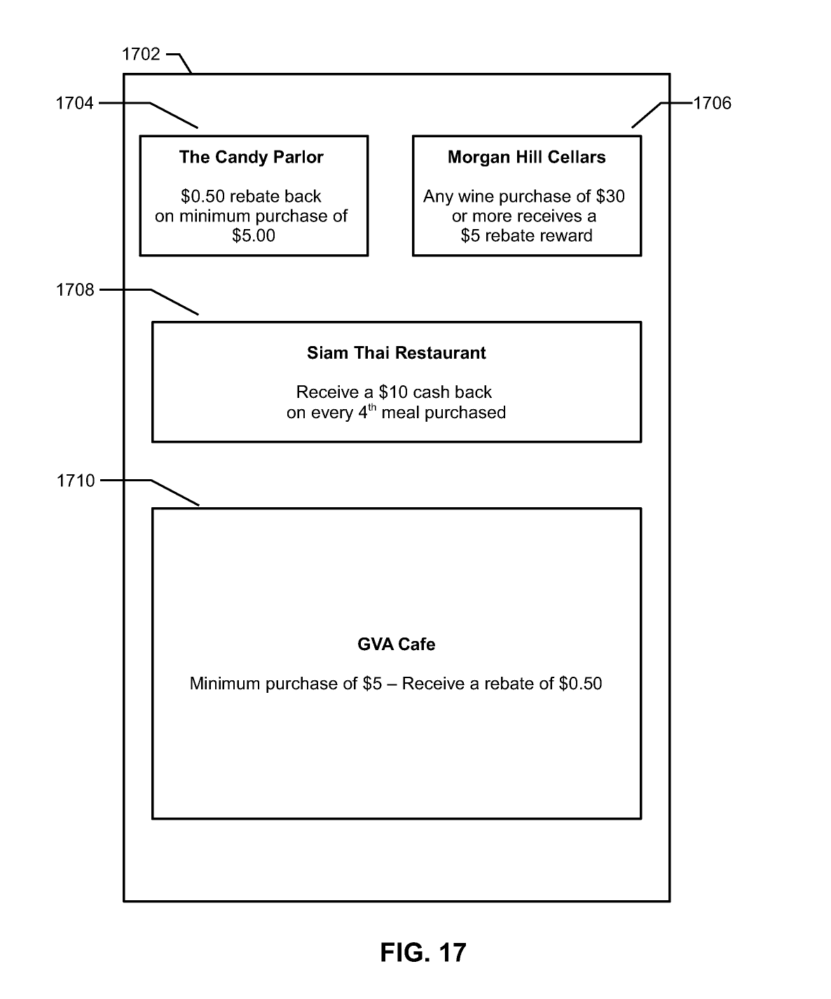

FIG. 17 depicts an embodiment of another user interface 1702 on a kiosk device. In some embodiments, a group of merchants can engage in a collaborative advertising program, wherein one merchant presents advertisements for the other merchants on their kiosk device. In one embodiment, user interface 1702 presents advertisement 1704, advertisement 1706, advertisement 1708 and advertisement 1710, wherein each advertisement is from a different merchant. In other embodiments, the user interface 1702 may be a dynamic interface as opposed to a static interface, wherein the advertisements change with time. For example, a sponsored ad may be displayed in a larger format than non-sponsored ads, and in a position that makes the sponsored ad more prominent as compared to non-sponsored ads.

In some embodiments, the application software on the customer device can also be used to display advertisements to the customer. In some embodiments, the customer device may show store ads of different sizes based on the size of their customer rewards. In other embodiments, the ads may be more prominent for sponsored merchants. In some embodiments, the GPS-based location of the customer may be used to present ads from merchant in the proximity of the customer. In other embodiments, a map-based display may be used to provide the location of merchants in the proximity of the customer. Each merchant may be assigned a unique location marker on the map, with the size of the location marker or the numeric value of the location marker visually indicating the size of the reward being offered by the merchant.

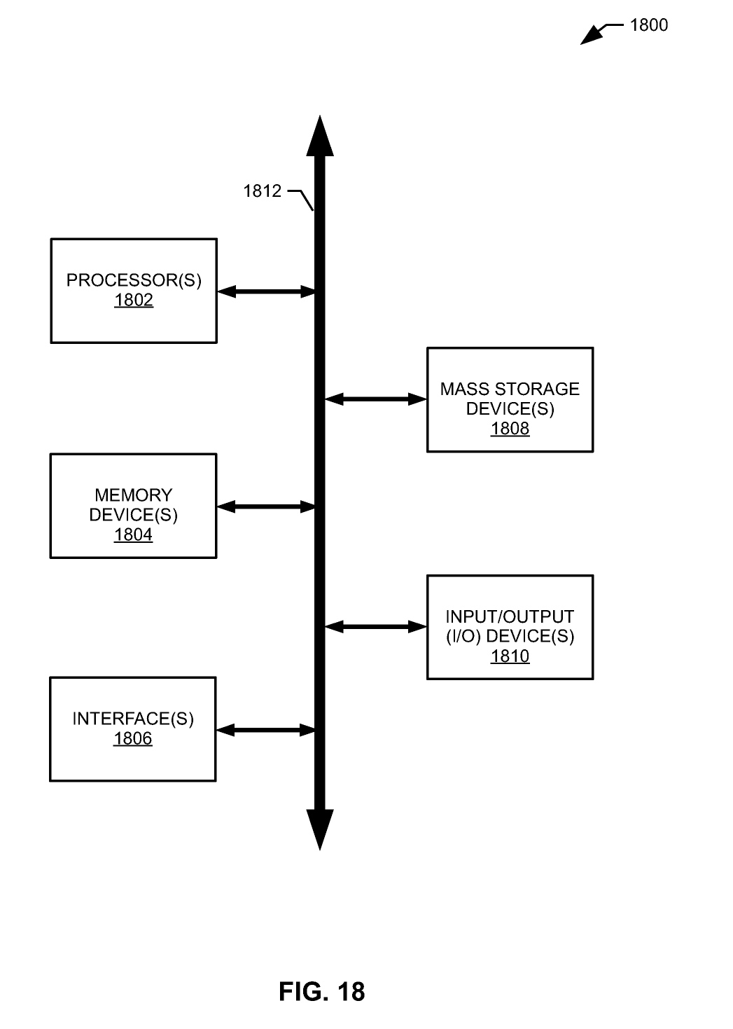

FIG. 18 is a block diagram 1800 that depicts a generalized processing architecture that can be used to implement the customer reward system and other systems and components discussed herein. Embodiments of the present invention can be implemented using a generalized processing architecture that includes one or more processors 1802, one or more memory devices 1804, one or more interfaces 1806, one or more mass storage devices 1808, and one or more input/output devices 1810, wherein all the different components that comprise the system are interfaced via a centralized bus 1812.

Although some of the embodiments described above discuss merchants with brick-and-mortar establishments, the systems and methods described herein can be extended to function with merchant e-commerce websites. Methods of including the customer reward program as a part of a merchant e-commerce website may include loose integration methods, where a customer completes an online purchase transaction on the website of a merchant participating in the customer reward program, and then separately claims their rewards on a separate website that is associated with the customer reward program by using their purchase receipt, their customer ID and the ID of the merchant participating the customer reward program. Other embodiments that implement the customer reward program to function with merchant e-commerce websites may include tight integration methods, where the reward process is a part of the checkout operation on the website of the merchant participating in the customer reward program. A customer with a valid account with the customer reward program may use the customer reward program during the purchase transaction by signing in to the associated account during the checkout process.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
receiving, through a merchant device, data associated with a purchase transaction by a customer, wherein the received data is entered into the merchant device by a user with knowledge of the transaction;
determining, using one or more processors, a customer reward associated with the purchase transaction based on the received data entered into the merchant device by the user with knowledge of the transaction;
communicating, using the one or more processors, the customer reward to a server that maintains a customer reward account associated with the customer; and
instructing the server to apply the customer reward to the customer reward account associated with the customer.

2. The method of claim 1, wherein the user has knowledge of the transaction based on information displayed by a point of sale device.

3. The method of claim 1, wherein the data associated with the purchase transaction includes a transaction price.

4. The method of claim 1, wherein the data associated with the purchase transaction includes an indication of at least one purchased item.

5. The method of claim 1, further comprising instructing the server to apply an additional customer reward to the customer reward account, wherein the additional customer reward is provided by an entity managing the customer reward account.

6. The method of claim 1, further comprising instructing the server to apply an additional customer reward to the customer reward account responsive to the customer referring another customer to open a new customer reward account.

7. The method of claim 1, further comprising instructing the server to issue the customer reward to the customer as a gift card or gift certificate that can be used with any of a plurality of merchants in a merchant community.

8. The method of claim 1, wherein a merchant associated with the purchase transaction pays a merchant fee to an entity managing the customer reward account, and wherein the merchant associated with the purchase transaction pays the customer reward to the customer reward account.

9. The method of claim 1, further comprising presenting a plurality of advertisements to the user based on the purchase transaction, wherein the plurality of advertisements are associated with a plurality of merchants in a common merchant network with the merchant associated with the purchase transaction.

10. An apparatus comprising:
a processor configured to receive data associated with a purchase transaction by a customer, and wherein the received data is received from a user with knowledge of the transaction based on information displayed on a point of sale device that processed the purchase transaction, and
a memory coupled to the processor and configured to store data associated with the transaction.

11. The apparatus of claim 10, wherein the processor is further configured to apply a customer reward to a customer reward account associated with the customer.

12. The apparatus of claim 11, wherein the customer reward amount is based on a transaction price.

13. The apparatus of claim 11, wherein the customer reward amount is based on a particular item purchased.

14. The apparatus of claim 11, wherein the processor is further configured to communicate the customer reward to a server that maintains the customer reward account associated with the customer and instruct the server to apply the customer reward to the customer reward account associated with the customer.

15. An apparatus comprising:
a point of sale device configured to process a purchase transaction for a customer, wherein the purchase transaction identifies an associated transaction price and at least one purchased item; and
a merchant device configured to receive transaction price information and purchased item information entered by a user proximate the point of sale device, the merchant device further configured to apply a customer reward to a customer reward account associated with the customer, wherein the customer reward amount is based on the transaction price or the purchased item.

16. The apparatus of claim 15, further comprising a kiosk device configured to receive input from the customer and, based on the received input, present customer reward account information to the customer.

17. The apparatus of claim 15, further comprising a kiosk device configured to present advertisements to the customer based on customer profile information.

18. The apparatus of claim 15, wherein the customer reward amount is further based on previous customer purchase transactions.

19. The apparatus of claim 15, wherein the customer reward amount is further based on a reward level determined by the user.

20. The apparatus of claim 15, wherein the customer reward is redeemable at a plurality of merchants in a common merchant network.
